(19) United States
(12) Patent Application Publication
(10) Pub. No.: US 2024/0409185 A1
(43) Pub. Date: Dec. 12, 2024

(54) MARINE HYDROFOILING OPERATION CONTROL

(71) Applicant: VOLVO PENTA CORPORATION, Gõteborg (SE)

(72) Inventors: Felix LUNDGREN, Hisingsbacka (SE); Andreas HÖRBERG, Göteborg (SE)

(21) Appl. No.: 18/733,270

(22) Filed: Jun. 4, 2024

(30) Foreign Application Priority Data
Jun. 7, 2023 (SE) 2350689-2

(51) Int. Cl. B63B 1/28; B63B 79/10; B63B 79/20; B63B 79/40

(52) U.S. Cl. CPC B63B 1/285; B63B 79/10; B63B 79/20; B63B 79/40

(57) ABSTRACT

A computer system includes processing circuitry configured to: obtain data indicative of a target total lift force to be generated by a front hydrofoil arrangement of a marine vessel and by a rear hydrofoil arrangement of the marine vessel, wherein the target total lift force is associated with a constant heave of the vessel; determine a lift force discrepancy between a current lift force of the vessel and the target total lift force, based on a state of the rear hydrofoil arrangement; and adjust an angle of attack of the front hydrofoil arrangement to compensate for the lift force discrepancy.

### TECHNICAL FIELD

The disclosure relates generally to marine vessels. In particular aspects, the disclosure relates to marine hydrofoiling operation control. The disclosure can be applied to marine vessels, such as leisure boats, ships, cruise ships, fishing vessels, yachts, ferries, among other vehicle types. Although the disclosure may be described with respect to a particular marine vessel, the disclosure is not restricted to any particular marine vessel

### BACKGROUND

With the recent focus on electric propulsion systems in the marine industry, hydrofoils have gained renewed interest. Generally, hydrofoiling vessels utilize retractable wings or foils that, when extended at higher speeds, generate sufficient lift to elevate the hull out of the water. The hydrofoiling vessel thereby benefits from a higher lift-to-drag ratio, which implies that the vessel can be propelled with less energy compared to, for example, hull displacement vessels. In the past, hydrofoils were designed to be stable and fixed, meaning they did not require any external control. However, by making the attack angles of the wings in the hydrofoil system variable and thus potentially introducing instability in the system, it is possible to improve its performance. To fully utilize this type of variable attack angle hydrofoil system, control of the hydrofoiling operation is desired.

It is in view of the considerations above and others that the present inventors herein are suggesting one or more improvement to the prior art.

### SUMMARY

A computer system is thus employed herein that involves processing circuitry for controlling the hydrofoiling operation, preferably in real-time. The computer system (sometimes also referred to as a hydrofoil flight controller) should be flexible and preferably able to control hydrofoiling operations on several different types of vessels, at different speeds, and in varying environmental conditions.

According to a first aspect of the disclosure, a computer system is provided. The computer system comprises processing circuitry configured to obtain data indicative of a target total lift force to be generated by a front hydrofoil arrangement of a marine vessel and by a rear hydrofoil arrangement of the marine vessel, wherein the target total lift force is associated with a constant heave of the vessel; determine a lift force discrepancy between a current lift force of the vessel and the target total lift force, based on a state of the rear hydrofoil arrangement; and adjust an angle of attack of the front hydrofoil arrangement to compensate for the lift force discrepancy. The first aspect of the disclosure may seek to enhance the stability and performance of marine vessels by dynamically adjusting hydrofoil configurations. A technical benefit may include improved vessel control and reduced energy consumption during navigation.

Optionally in some examples, including in at least one preferred example, the processing circuitry is configured to determine the target total lift force based on data indicative of a mass of the vessel, and a model of lift force by the front hydrofoil arrangement and by the rear hydrofoil arrangement. A technical benefit may include increased accuracy in maintaining desired vessel dynamics.

Optionally in some examples, including in at least one preferred example, the processing circuitry is further configured to determine the lift force discrepancy based on a current pitch of the vessel, a speed through water of the vessel, and a total rear lift force currently generated by the rear hydrofoil arrangement. A technical benefit may include enhanced responsiveness to changing environmental conditions and vessel states.

Optionally in some examples, including in at least one preferred example, the processing circuitry is further configured to determine a current lift force generated by the front hydrofoil arrangement, and a current lift force generated by the rear hydrofoil arrangement, respectively, as:

$${F}_{L , front} = \frac{{v}^{2} {A}_{f} ρ {C}_{L} ( {β}_{f} )}{2} , and {F}_{L , rear , tot} = {F}_{L , rear , 1} + {F}_{L , rear , 2} = \frac{{v}^{2} {A}_{r 1} ρ {C}_{L} ( {β}_{r 1} )}{2} + \frac{{v}^{2} {A}_{r 2} ρ {C}_{L} ( {β}_{r 2} )}{2} ,$$

where v is a speed through water of the vessel, A_{f}, Aᵣ₁, and Aᵣ₂ are wing areas associated with the front hydrofoil arrangement and with the rear hydrofoil arrangement respectively, ρ is a water density, C_{L}(·) is a lift coefficient as function of an attack angle, β_{f}, βᵣ₁, βᵣ₂, associated with the front hydrofoil arrangement, and with the rear hydrofoil arrangement, respectively.

Optionally in some examples, including in at least one preferred example, the processing circuitry is further configured to determine a desired set angle of the front hydrofoil arrangement, as:

$${α}_{f} = \frac{2 ( m g - {F}_{L , rear , t o t} )}{{v}^{2} {A}_{f} ρ k} - θ - \frac{c}{k} ,$$

where m is vessel mass, g is a gravitational acceleration on Earth, F_{L,rear,tot} is a current lift force generated by the rear hydrofoil arrangement, v is a speed through water of the vessel, p is a water density, A_{f} is a wing area of the front hydrofoil arrangement, θ is a pitch of the vessel, and where a lift coefficient C_{L} of the front hydrofoil arrangement is approximated by a straight line given by C_{L}≈ka_{f}+c.

Optionally in some examples, including in at least one preferred example, the processing circuitry is further configured to control heave of the vessel to reduce a difference between a current vessel heave and a heave set-point by the front hydrofoil arrangement. A technical benefit may include improved stability and maneuverability of the vessel in various sea conditions. A technical benefit may include improved stability and maneuverability of the vessel in various sea conditions.

Optionally in some examples, including in at least one preferred example, the processing circuitry is further configured to control pitch of the vessel to reduce a difference between a current vessel pitch and a pitch set-point by the rear hydrofoil arrangement. A technical benefit may include improved stability and maneuverability of the vessel in various sea conditions.

Optionally in some examples, including in at least one preferred example, the processing circuitry is further configured to control roll of the vessel to reduce a difference between a current vessel roll and a roll set-point by the rear hydrofoil arrangement. A technical benefit may include improved stability and maneuverability of the vessel in various sea conditions.

Optionally in some examples, including in at least one preferred example, the processing circuitry is further configured to control the roll of the vessel based on a rudder turn angle. A technical benefit may include improved stability and maneuverability of the vessel in various sea conditions.

According to a second aspect of the disclosure, a marine vessel is provided. The marine vessel comprises a front hydrofoil arrangement, a rear hydrofoil arrangement, and the computer system according to the first aspect. This aspect seeks to integrate advanced hydrofoil management into marine vessel designs. A technical benefit may include enhanced vessel performance and passenger comfort by maintaining optimal hydrofoil configurations.

Optionally in some examples, including in at least one preferred example, the front hydrofoil arrangement and the rear hydrofoil arrangement are arranged to lift the marine vessel out of the water into a hydrofoiling state where a hull of the vessel is elevated from a nominal draught state to a state of reduced draught. A technical benefit may include reduced water resistance and increased vessel speed and efficiency during navigation.

According to a third aspect of the disclosure, a hydrofoiling system is provided. The hydrofoiling system comprises at least a front hydrofoil arrangement, a rear hydrofoil arrangement, and the computer system according to the first aspect. This aspect aims to provide a modular solution for retrofitting existing vessels or designing new hydrofoil-equipped vessels. A technical benefit may include versatility and adaptability in hydrofoil system implementations across different vessel types.

According to a fourth aspect of the disclosure, a computer-implemented method for controlling a hydrofoiling operation by a marine vessel is provided. The method comprises obtaining, by processing circuitry of a computer system, data indicative of a target total lift force to be generated by a front and rear hydrofoil arrangement of the marine vessel, determining a lift force discrepancy based on a state of the rear hydrofoil arrangement, and adjusting an angle of attack of the front hydrofoil arrangement to reduce the lift force discrepancy. This aspect seeks to implement the hydrofoil management strategies in a methodical manner. A technical benefit may include streamlined integration into existing vessel control systems.

According to a fifth aspect of the disclosure, a computer program product is provided. The computer program product comprises program code for performing the method of the fourth aspect when executed by the processing circuitry. This aspect seeks to provide a software solution that can be integrated into various marine vessel systems to enhance operational efficiency and performance. A technical benefit may include the ease of deployment across different computing platforms in marine vessels, enabling consistent and reliable hydrofoil management.

According to a sixth aspect of the disclosure, a non-transitory computer-readable storage medium is provided. The non-transitory computer-readable storage medium comprises instructions, which when executed by the processing circuitry, cause the processing circuitry to perform the method of the fourth aspect. This aspect aims to ensure that the methodologies for dynamic hydrofoil management are sustainably embedded within the vessel's control systems, providing long-term benefits. A technical benefit may include improved durability and reliability of the hydrofoil control system, reducing the need for frequent recalibrations or adjustments under varying operational conditions.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 is an exemplary schematic illustration of a marine vessel arranged for hydrofoiling according to an example.

FIG. 2 is an exemplary diagram illustrating a relationship between lift coefficient and attack angle according to an example.

FIG. 3 is an exemplary block diagram illustration of a part of a control method according to an example.

FIG. 4 is an exemplary block diagram illustration of a control system for a hydrofoiling operation according to an example.

FIG. 5A show illustrative diagrams involving roll, pitch, and heave, in relation to respective setpoints in exemplary hydrofoiling operations according to an example.

FIG. 5B show illustrative diagrams involving roll, pitch, and heave, in relation to respective setpoints in exemplary hydrofoiling operations according to an example.

FIG. 5C show illustrative diagrams involving roll, pitch, and heave, in relation to respective setpoints in exemplary hydrofoiling operations according to an example.

FIG. 5D show illustrative diagrams involving roll, pitch, and heave, in relation to respective setpoints in exemplary hydrofoiling operations according to an example.

FIG. 5E show illustrative diagrams involving roll, pitch, and heave, in relation to respective setpoints in exemplary hydrofoiling operations according to an example.

FIG. 6 is an exemplary schematic illustration of a marine vessel arranged for hydrofoiling according to an example, the marine vessel including a hydrofoiling wand for measuring heave.

FIG. 7 is a flowchart of an exemplary method for controlling a hydrofoiling operation by a marine vessel according to an example.

FIG. 8 is a schematic diagram of an exemplary computer system for implementing examples disclosed herein, according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The general concept as defined herein in the respective aspects of the disclosure may be applicable to vessels comprising more than two hydrofoil arrangements, such as a vessel comprising three or more hydrofoil arrangements, where each hydrofoil arrangement may comprise one or more hydrofoiling wings. The aspects determine a required total lift force by the hydrofoil arrangements in order to maintain a constant heave of the vessel hull relative to the water surface. This lift force requirement is then compared to a current lift force generated by the hydrofoil arrangements on the vessel, which is determined based on a state of the rear hydrofoil arrangement. Any discrepancy between required lift force and current lift force is then compensated for by the front hydrofoil arrangement. This means for instance that any effect on lift force caused by pitch motion generated by the rear hydrofoil arrangement is quickly compensated for by the front hydrofoil arrangement.

Thus, advantageously, pitch and heave are separated from each other, which simplifies control of the hydrofoiling operation. Both the total lift force requirement, i.e., the target total lift force, and the currently generated lift force are determined based on respective states of the hydrofoiling actuators and on models of lift force for the different hydrofoil arrangement. This can allow for a feed-forward control system with relatively low latency.

The aspects may for instance involve determining the target total lift force based on data indicative of a mass of the vessel, and on a model of lift force by the front hydrofoil arrangement and by the rear hydrofoil arrangement. Thus, the aspects can be conveniently tailored to a given vessel type and hull shape by adapting the mass parameter and the model of lift force. To this end, a sophisticated approach tailored to enhancing the stability and performance of marine vessels equipped with multiple hydrofoil arrangements may be provided. This system can also be beneficial for vessels featuring three or more hydrofoil arrangements, each potentially comprising multiple hydrofoiling wings. By managing the lift forces generated by these hydrofoils, the invention aims to maintain a constant heave of the vessel's hull relative to the water surface, irrespective of varying conditions and operational demands.

The approaches herein thus provide multiple hydrofoil arrangements to generate a distributed lift force that can be finely tuned to the vessel's center of gravity and dynamic loading conditions. Continuous monitoring of all hydrofoils, with a focus on the rear hydrofoil, can allow for real-time assessment of vessel dynamics. Discrepancies between required and actual lift forces can be quickly corrected by adjusting the front hydrofoil's angle of attack, effectively decoupling pitch control from heave stability. The feed-forward control strategy may also be enhanced by real-time data processing, which can ensure quick responses to changes in sea conditions, speed, or load distribution. This precise control over multiple hydrofoils may not only improves vessel stability, which is important for high-speed operations close to the water surface, but may also evenly distribute mechanical stress across the hydrofoils, extending their lifespan. Additionally, maintaining constant heave can enhance onboard comfort by minimizing vertical movements and increases safety by reducing risks associated with hydrofoil submersion or emergence. The solution works by customizations of performance based on specific vessel characteristics like type, hull shape, and weight.

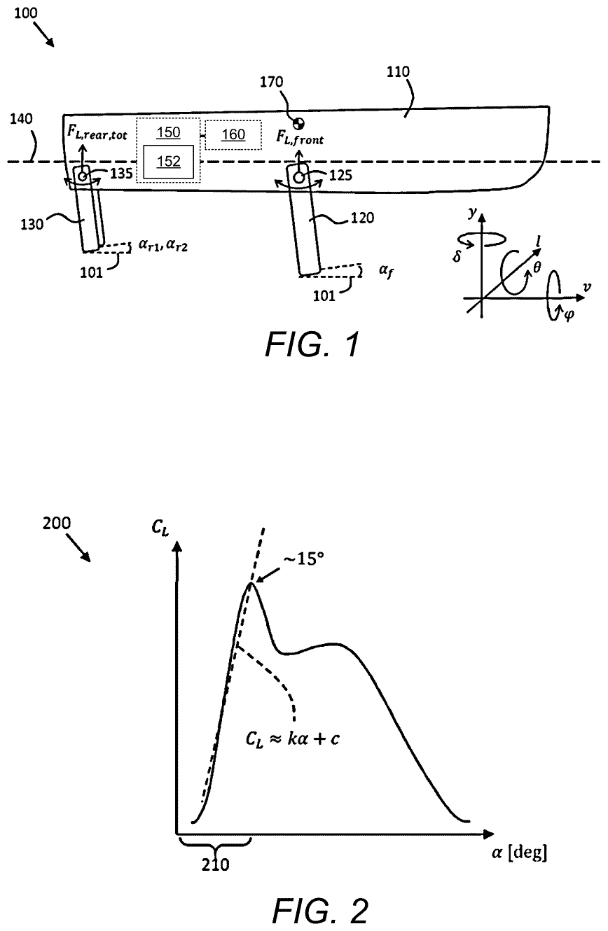

FIG. 1 illustrates an exemplary marine vessel 100 arranged for hydrofoiling operation. The hull 110 of the vessel 100 comprises a front hydrofoil arrangement 120 and a rear hydrofoil arrangement 130. In this particular example the front hydrofoil arrangement 120 comprises a single hydrofoil wing pivotable arranged about a front pivot point 125. The rear hydrofoil arrangement according to the example in FIG. 1 comprises left and right hydrofoil wings that can be controlled independently of each other. This is, for example, for purposes of generating yaw motion by the hull 110. The rear hydrofoil arrangement 130 is arranged pivotable about a rear pivot point or points 135. Each hydrofoil arrangement comprises at least one hydrofoiling wing supported by respective struts on the vessel hull. In other examples the rear or front hydrofoil arrangements 120, 130 may include one or more hydrofoils each.

One or more actuators are arranged to control the pivot angles of the front and rear hydrofoil arrangements. The configured angle of the front hydrofoil arrangement 120 relative to some reference plane, such as the horizontal plane 101, referred to as the set angle below, is denoted α_{f}. The rear hydrofoil arrangement 130 has respective configured angles relative to the reference plane denoted αᵣ₁ and αᵣ₂, respectively.

The longitudinal velocity of the vessel 100 is denoted v and the lateral velocity of the vessel 100 is denoted l. The heave of the vessel, i.e., the height of the vessel 100 over the sea-level 140 is denoted y. Yaw angle relative to some reference direction is denoted δ, pitch angle is denoted θ, and roll angle is denoted φ, as illustrated in FIG. 1.

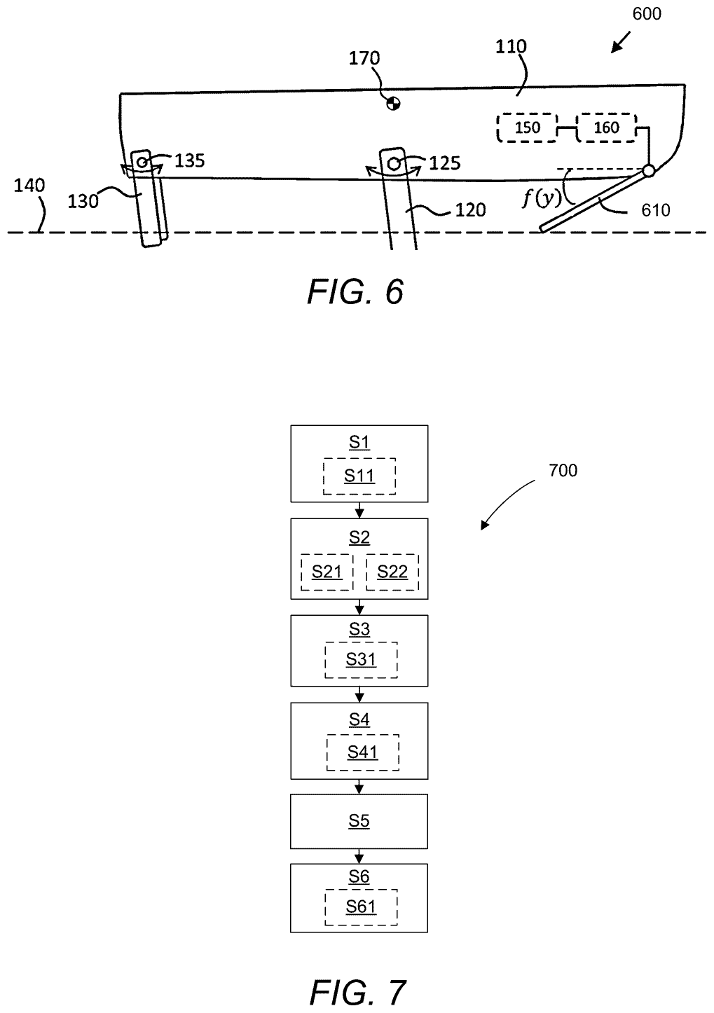

The hydrofoiling operations performed by the vessel 100 are controlled by processing circuitry 152 of a computer system 150. The computer system 150 will be discussed in more detail below. The processing circuitry 152 may comprise a single processing device or a more than one processing device part of a distributed control system. The processing circuitry 152 is connected to one or more sensors that form part of a vessel motion sensor system 160. These motion sensors may include but is not limited to including inertial measurement units (IMU), satellite positioning receivers such as GPS receivers, and speed logs arranged to determine the speed through water v of the vessel 100. The vessel motion sensor system 160 may also comprise one or more sonar sensors arranged to monitor a speed over ground of the vessel 100. The IMU measures acceleration in the longitudinal and lateral directions, as well as vertical acceleration. The IMU may also comprise a gyro which provides rotations about the different reference axes. A hydrofoil wand, as illustrated in FIG. 6, can be used to determine the heave y of the vessel 100 according to methodologies known in the art, such as wave height measurements to calculate vertical displacement, employing accelerometers to record heave motion, or utilizing GPS-based systems to track changes in elevation relative to a fixed reference point.

The vessel 100 has a mass or displacement which will be denoted m herein. The mass is associated with a mass center 170. The front hydrofoil arrangement 120 is located forward of the rear hydrofoil arrangement 130, in the normal forward motion direction of the vessel. However, certain advantages are obtained if the front hydrofoil arrangement 120 is arranged in vicinity of the mass center 170 of the vessel, which is often somewhere around the longitudinal midpoint of the vessel 100. The vessel mass m may for example be determined from a water-line sensor which monitors how deep in the water the vessel lies when stationary. The vessel mass m may also be preconfigured and assumed to be approximately constant.

It is appreciated that the vessel 100 illustrated in FIG. 1, and its hydrofoil arrangements 120, 130, are general examples. The techniques of the present disclosure can be applied to other vessel types, with other hull shapes. The different methods for hydrofoiling operation disclosed herein can also be applied with other types of hydrofoil arrangements, such as arrangements comprising more than three hydrofoiling wings, and also with hydrofoil arrangements comprising a combination of controllable angle wings and fixed angle wings.

Hydrofoiling techniques have generated a new interest among boat makers, as they offer a new market opportunity for boat builders. It is important for boat builders to ensure that hydrofoil boats provide comfort in different conditions and maintain stability even when weight, such as people on board, is shifted around during driving. This puts a lot of effort on control mechanisms, which must maintain the boat's stability and robustness, while also allowing it to drive like a traditional boat at low speeds and transition into foiling mode at higher speeds. Additionally, the control mechanisms must keep track of the height above the water surface to maintain its level and comfort, even in the presence of waves or other disturbances. Boat builders therefore have an interest in developing control mechanisms that can handle these challenges.

The lift force F_{L} of a hydrofoil arrangement and the drag force F_{D} of a hydrofoil arrangement both play a role in the hydrofoiling operation. The lift force F_{L} is especially important as it enables the hydrofoil to achieve lift force, allowing the boat to “fly” above the water surface. When the boat gains enough lift force, the hull starts to rise above the water surface (sometimes referred to as hull displacement mode) and with the attached submerged wings, the system transitions into airplane dynamics, rather than traditional boat dynamics. These forces can be modeled using equations that describe the behavior of fluid dynamics, such as the well-known Navier-Stokes equations.

The lift force F_{L} can be derived from Bernoulli's principle, as well as other factors such as the surface area A of the wing, the density p of the fluid around the wing and the velocity v of the fluid as it moves over the wing. The lift force is generated by pressure differences in the fluid surrounding the wing, which creates an upward force that lifts the hydrofoil. In contrast, the drag force F_{D} creates a resistance force in the moving direction of the wing's motion. The lift force and the drag force may be determined, at least approximately, as:

$${F}_{L} = \frac{{C}_{L} ( β ) {v}^{2} A ρ}{2} , and$$

$${F}_{D} = \frac{{C}_{D} ( β ) {v}^{2} A ρ}{2} ,$$

where v is the speed of the water as it moves over the wing, A is the surface area of the wing, and ρ is the density of the water. C_{L} and C_{D} are lift and drag coefficients, respectively, and they are functions of the attack angle β of the wing. These coefficients depend on the angle of attack (AoA) β, generally in a non-linear manner. Understanding the lift and drag forces involved in the operation of a hydrofoil boat is important for developing an accurate control strategy.

The generation of lift and drag forces depend on the angle of attack β, which is determined by two angles: the vessel's pitch angle θ and the hydrofoils' set angles α. The angle of attack of a hydrofoil wing is the angle between the wing chord line and the general direction of oncoming fluid flow. The vessel's orientation in relation to the reference plane (normally the horizontal plane) determines the pitch angle, and the set angle is determined by the actuator that rotates the strut attached to the hydrofoil, allowing for independent control of the AoA of each hydrofoil. Generally, for a hydrofoil arrangement, the AoA can be approximated as:

$$β \approx θ + α ,$$

where θ is the pitch, and α is the set angle of the hydrofoil wing relative to some reference plane. With a constant increase in AoA, the lift coefficient will eventually pass its peak, entering what is known as the stall region, as illustrated in FIG. 2. Stalling occurs when the fluid flows across both sides of a wing separates, reducing lift force. The lift coefficient rapidly decreases as the drag coefficient begins to increase. This sudden reduction in lift can cause a critical loss in stability. It is worth noting that stalling in a hydrofoil boat is not as critical as in an airplane, because the boat travels close to the water surface.

A flight controller of a hydrofoil arrangement has three main states to regulate: roll φ, pitch θ, and heave y. The time derivatives of the three states can also be controlled, as an option. The controller regulates these states by adjusting the set angles of the hydrofoil wings on the vessel. In the example of FIG. 1, three set angles are controlled—two at the rear hydrofoil arrangement 130 and one at the front hydrofoil arrangement 120. However, as discussed above, any number of hydrofoil wings may be used, where each hydrofoil wing has a respective set angle to be regulated, unless the wing is a fixed hydrofoil wing which is also possible. Roll regulation of the hydrofoil system can be implemented independently, while pitch and heave control have a relation that causes their regulations to affect each other. This is due to the fact that a change in pitch also causes a change in AoAs of the hydrofoils, resulting in a shift in total lift force and heave height.

The processing circuitry 152 adapted to control the hydrofoiling operation according to teachings herein may incorporate an algorithm which is herein referred to as front foil compensation (FFC). This is an algorithm that determines a set angle for the front hydrofoil to prevent heave changes during pitch control.

The processing circuitry 152 for the hydrofoil arrangement on the vessel 100 (or on other vessels) may for example be implemented using a plurality of control loops, such as proportional-integral-derivative (PID) control loops. According to one example, the core of the processing circuitry 152 consists of three PID controllers, although other realizations are also possible. A PID controller is one of the most widely used controllers, and it includes an algorithm that calculates an error based on the difference between a desired setpoint and a feedback value of the state to be controlled in a known manner.

The processing circuitry 152 built around three PID controllers preferably controls roll, pitch, and heave by respective control loops. Roll and pitch are preferably controlled by the rear hydrofoils 130, motivated by their further distance from the center of mass 170, thus providing a longer moment arm. The front hydrofoil 120 regulates heave, motivated by its larger area, which generates more lift force compared to the rear hydrofoils. Furthermore, its proximity to the center of mass 170 makes it particularly suitable for translational motion.

FFC is an algorithm that aims to separate the link between pitch and heave control of the hydrofoiling operation. It does this by computing a difference angle or delta angle that the front hydrofoil arrangement 120 utilizes to compensate for the operations of the rear hydrofoil arrangement 130 on the heave by the vessel 100. While the vessel 100 is foilborne, the rear and front hydrofoil arrangements 120, 130 have to generate a joint total lift force that is equal to the boat's gravitational pull force, to keep it at a constant heave. Since pitch and heave are controlled separately by their own regulators, they will not affect each other, at least not significantly, while FFC is active. The algorithm may, e.g., use the pitch and velocity of the vessel 100, and the total lift force generated by the rear hydrofoil arrangement 130, to calculate a desired set angle for the front hydrofoil arrangement 120. To acquire the delta angle from the desired angle, the current set angle of the front hydrofoil arrangement 120 is used.

The desired angle of the front hydrofoil arrangement 120 is for instance derived from the lift force equation, the lift force coefficient, and from a force balance based on the total lift force Fₜₒₜ of the hydrofoil arrangements on the boat, as:

$${F}_{t o t} = m g = {F}_{L , front} + {F}_{L , rear , tot} ,$$

$$or$$

$${F}_{L , front} = m g - {F}_{L , rear , tot} ,$$

where m is the mass of the vessel 100, g is the gravitational acceleration on Earth, i.e., approximately 9.81 m/s², F_{L,front} is the lift force generated by the front hydrofoil arrangement 120 and F_{L,rear,tot} is the lift force generated by the rear hydrofoil arrangement 130. The lift equation gives:

$${F}_{L , front} = \frac{{v}^{2} {A}_{f} ρ {C}_{L} ( {β}_{f} )}{2} ,$$

where subscript f on the wing area A_{f} and AoA β_{f} here denotes the front hydrofoil arrangement 120. This relationship, when taken together with the relationship F_{L,front}=mg−F_{L,rear,tot}, gives:

$${C}_{L} ( {β}_{f} ) = \frac{2 ( m g - {F}_{L , rear , tot} )}{{v}^{2} {A}_{f} ρ}$$

The lift coefficient can be approximated using the equation of a straight line:

$${C}_{L} ( β ) \approx k β + c = k θ + k α + c ,$$

where k is the line gradient and c is the height at which the line crosses the y-axis, also known as the y-intercept of the line.

The lift coefficient follows this straight line well in an initial span 210, e.g., from zero to about 15 degrees AoA, which can be seen in the example 200 of FIG. 2. This is a span in which the AoA will almost always be in while the boat is foilborne.

Combining the above to solve for the desired set angle α_{f} of the front hydrofoil arrangement 120, the following approximate relationship is obtained:

$${α}_{f} \approx \frac{2 ( m g - {F}_{L , rear , t o t} )}{{v}^{2} {A}_{f} ρ k} - θ - \frac{c}{k} .$$

After obtaining the desired set angle α_{f} of the front hydrofoil arrangement 120, the delta angle, i.e., the set angle control adjustment for constant heave operation, can be calculated by subtracting by the current angle α_{current} of the front hydrofoil arrangement 120:

$$Δ α = {α}_{f} - {α}_{current} .$$

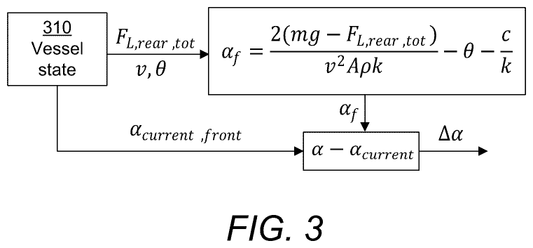

The FFC algorithm continues and sends its output to the front hydrofoil actuators, which can be thought of as setting the front hydrofoil arrangement 120 to a neutral angle (neutral as in not affecting heave), right before the heave control outputs its signal. The heave regulator will only increase or decrease the set angle of the front hydrofoil arrangement 120, after FFC, depending on the boat's heave error. Thereby, FFC essentially gives the heave regulator a good angle to start acting from each update. The FFC algorithm is illustrated in one example by the block diagram 300 in FIG. 3, where the vessel state block 310 is a software module configured to maintain information relating to the state of the vessel 100 and also a model of lift force by the rear hydrofoil arrangement 130. The vessel state block 310 provides data indicative of the speed through water V, the vessel pitch θ and the total rear lift force F_{L,rear,tot} generated by the rear hydrofoil arrangement 130.

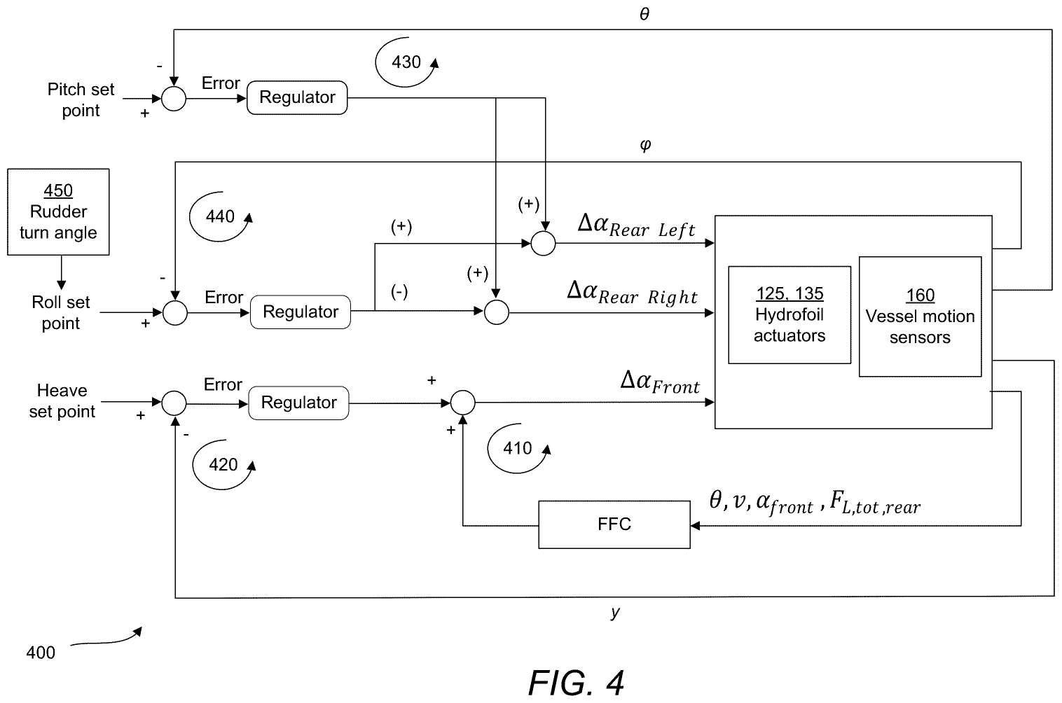

FIG. 4 is a block diagram of an example control system 400 for controlling a hydrofoiling operation of a vessel, such as the vessel 100 in FIG. 1.

The FFC algorithm is here implemented as an inner loop 410 in the heave control part of the control system 400. The inner loop 410 targets maintaining a constant heave, as discussed above, while an outer heave control loop 420 controls the set angle of the front hydrofoil arrangement 120 to reduce a difference between a current heave y of the vessel 100 and a heave set point. The combination of inner loop 410 and outer loop 420 generates an adjustment Δα_{front} which is an incremental adjustment value that is sent to the front hydrofoil arrangement angle actuator.

A separate control loop 430 is used to control pitch θ. This control loop is configured to control the states of the rear hydrofoil arrangement 130 and does not have an effect on the front hydrofoil arrangement 120. The pitch control loop generates an adjustment Δα_{rear,left}, α_{rear,right} for each of the rear hydrofoil wings in the rear hydrofoil arrangement 130.

The roll of the vessel 100 is controlled by the control loop 440 and is configured to generate a roll motion by the vessel in dependence of a rudder turn angle 450. The roll control loop also generates an adjustment Δα_{rear,left}, α_{rear,right} for each of the rear hydrofoil wings in the rear hydrofoil arrangement 130.

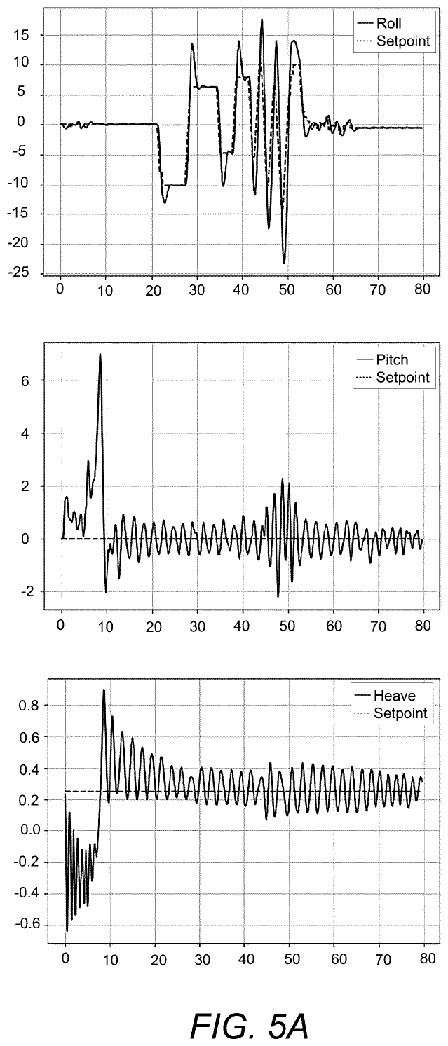

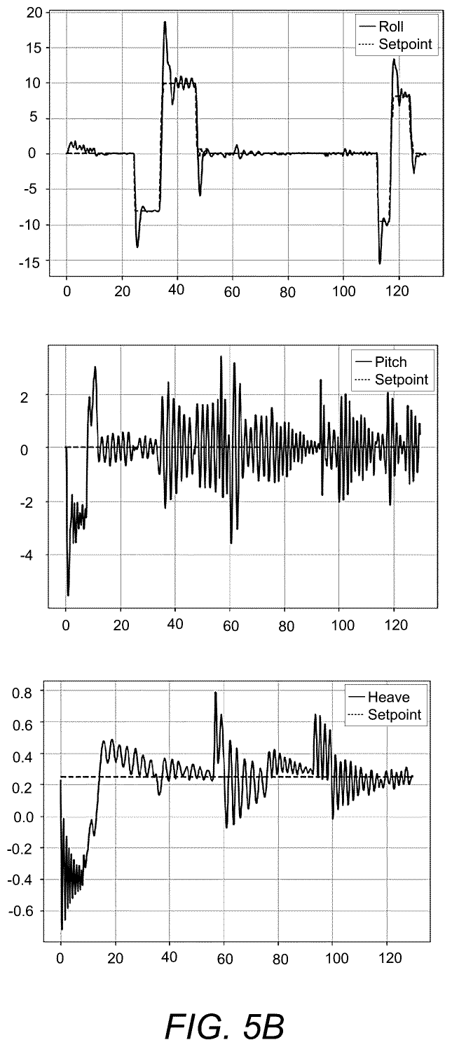

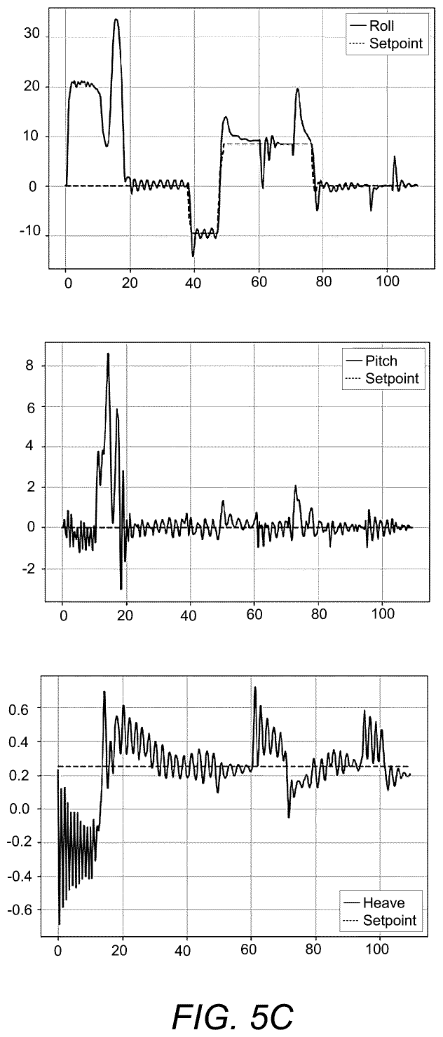

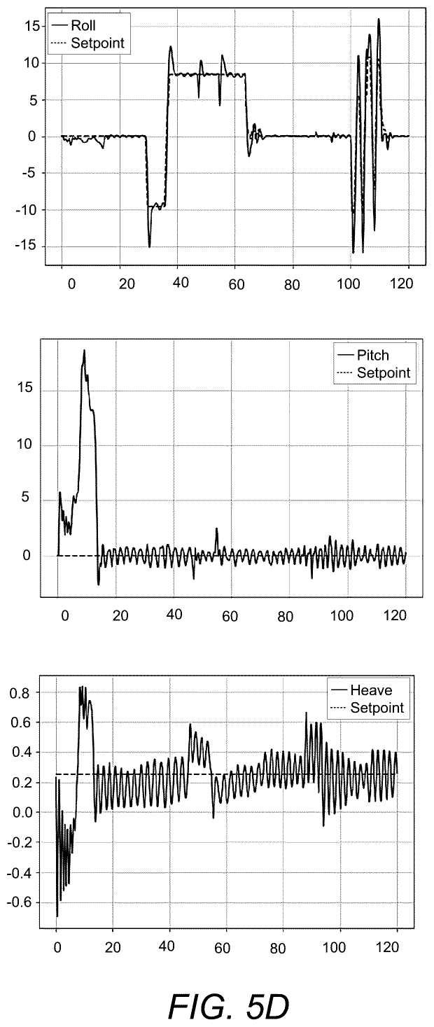

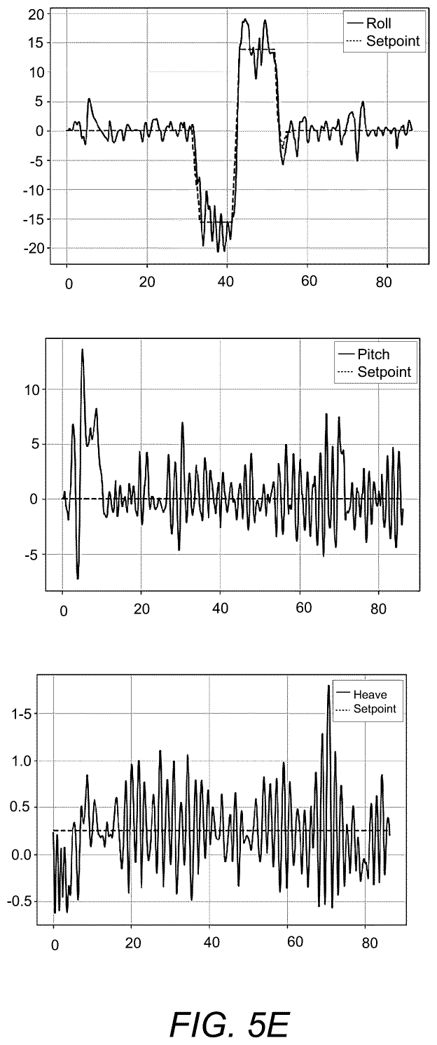

FIGS. 5A-E illustrate various performance examples of the hydrofoiling control techniques discussed herein. FIGS. 5A-E illustrate roll, pitch, and heave of the vessel 100 in response to various changes in the respective set points over time. The performance of the controllers discussed above have been evaluated by moving the weight center of the vessel 100 around, and by investigating performance during various wind and sea conditions.

FIG. 5A illustrates a scenario with no extra weight added, with one person onboard the vessel 100, and during calm sea conditions. The scenario comprises starting the boat from a stand-still, and by operating the boat at around cruising speed (24 knots), in a realistic manner.

In FIGS. 5B-D a weight of 600 kg loaded the vessel 100 (simulating eight passengers) and sea conditions were calm. The extra weight is loaded at different locations of the vessel 100.

FIG. 5B shows a scenario where a front 600 kg weight was added at 52 s and at 90 s seconds and removed at 58 s and 98 s seconds.

FIG. 5C shows a scenario where a side 600 kg weight was added at 59 s and at 93 s seconds and removed at 69 s and at 100 s.

FIG. 5D shows a scenario where a rear 600 kg weight was added at 45 s and at 87 s and removed at 54 s and 93 s seconds.

FIG. 5E illustrates controller performance with no extra weight and windy sea conditions. Windy sea conditions consist of a disturbing wind at 20 m/s that affects the boat by pushing it from different directions, while also generating larger waves on the simulated ocean surface. The pitch and heave indicate that the controller was not entirely successful in effectively controlling the hydrofoiling operation during windy conditions. The magnitudes of the oscillations are large, displaying poor control of the boat.

In FIG. 6, a marine vessel 600 comprising a sensor arrangement is shown. The sensor arrangement is for measuring the height above water level, i.e., the heave y. This arrangement is generally known as a hydrofoil wand and comprises an elongated member 610 or rod that is towed. The angle between the member 610 and the sea surface f(θ) is a function of the heave y of the vessel.

FIG. 7 is a flowchart that illustrates a method 700. The method 700 summarizes at least some of the examples herein. The method 700 is a computer-implemented method, and can be carried out by the processing circuitry 152 as discussed herein for controlling a hydrofoiling operation by the marine vessel 100 as discussed herein. The vessel 100 comprises a front hydrofoil arrangement 120 and a rear hydrofoil arrangement 130, as exemplified in FIG. 1. The front hydrofoil arrangement 120 and the rear hydrofoil arrangement 130 are arranged to lift the vessel 100 out of the water into a hydrofoiling state where a hull of the vessel 100 is elevated from a nominal draught state to a state of reduced draught.

The method 700 comprises obtaining S1 data indicative of a target total lift force Fₜₒₜ to be generated by the front hydrofoil arrangement 120 and by the rear hydrofoil arrangement 130, where the target total lift force is associated with a constant heave y of the vessel 100. This target total lift force Fₜₒₜ is the lift force that counteracts forces that strive to bring the vessel closer to the sea surface, primarily the gravitational pull.

In some examples, the method 700 comprises determining S11 the target total lift force Fₜₒₜ based on data indicative of a mass m of the vessel 100, and on a model of lift force by the front hydrofoil arrangement 120 and by the rear hydrofoil arrangement 130. Different models of lift force can be used in the methods proposed herein. The models of lift force can be fixed or adaptive. An advantage of using adaptive models of lift force is that increased accuracy can be obtained, and also that the models can be tailored to better reflect actual lift force.

The method 700 comprises determining S2 a lift force discrepancy between a current lift force of the vessel 100 and the target total lift force, based on a state of the rear hydrofoil arrangement 130. The current lift force of the vessel 100 can, e.g., be obtained from a motion model that is configured to model the lift force provided by the vessel 100, given the current state of its actuators, such as the state of the front and the rear hydrofoil arrangements 120, 130. The motion model can be parameterized by the properties of the different hydrofoil arrangements on the vessel 100, such as the wing area and the AoA of each wing. Other properties such as the density of the surrounding seawater, and the speed of the water as it passes over the different wings of the hydrofoil arrangements 120, 130 on the vessel 100 is preferably also accounted for. The motion model can be at least in part determined based on physical models of reality, but it can also be adjusted as the vessel 100 is operated. This way the physical models can be made more accurate.

In some examples, the method 700 comprises determining S21 the lift force discrepancy based on a current pitch θ of the vessel 100, a speed through water v of the vessel 100, and on a total rear lift force F_{L,rear,tot} currently generated by the rear hydrofoil arrangement 130. The method may for instance comprise determining S22 a current lift force of the front hydrofoil arrangement 120, F_{L,front}, and of the rear hydrofoil arrangement 130, F_{L,rear,tot}, respectively, as:

$${F}_{L , front} = \frac{{v}^{2} {A}_{f} ρ {C}_{L} ( {β}_{f} )}{2} , and$$

$${F}_{L , rear , tot} = {F}_{L , rear , 1} + {F}_{L , rear , 2} = \frac{{v}^{2} {A}_{f} ρ {C}_{L} ( {β}_{r 1} )}{2} + \frac{{v}^{2} {A}_{f} ρ {C}_{L} ( {β}_{r 2} )}{2} ,$$

where v is a speed through water of the vessel 100, A_{f}, Aᵣ₁, and Aᵣ₂ are wing areas associated with the front hydrofoil arrangement 120 and with the rear hydrofoil arrangement 130 respectively, p is a water density, C_{L}(·) is a lift coefficient as function of an attack angle, β_{f}, βᵣ₁, βᵣ₂, associated with the front hydrofoil arrangement 120 and with the rear hydrofoil arrangement 130 respectively.

Knowing the target total lift force Fₜₒₜ that is needed in order to maintain a constant heave, and the current lift force that is generated by the hydrofoil arrangements 120, 130 on the boat, the method 700 adjusts S3 an angle of attack (AoA) of the front hydrofoil arrangement 120 to reduce the lift force discrepancy, thus counteracting any actuation performed by the rear hydrofoil arrangement.

In some examples, the method 700 comprises determining S31 a desired set angle α_{f} of the front hydrofoil arrangement 120, as:

$${α}_{f} = \frac{2 ( m g - {F}_{L , rear , t o t} )}{{v}^{2} {A}_{f} ρ k} - θ - \frac{c}{k} ,$$

where m is vessel mass, g is a gravitational acceleration on Earth, F_{L,rear,tot} is a current lift force generated by the rear hydrofoil arrangement 130, v is a speed through water of the vessel 100, ρ is a water density, A_{f} is a wing area of the front hydrofoil arrangement 120, θ is a pitch of the vessel 100, and where a lift coefficient C_{L} of the front hydrofoil arrangement 120 is approximated by a straight line given by C_{L}≈ka_{f}+c.

In some examples, the method 700 comprises controlling S4 heave y of the vessel 100 to reduce a difference between a current vessel heave and a heave set-point by the front hydrofoil arrangement 120. The method 700 may for instance comprise controlling S41 heave y of the vessel 100 by the front hydrofoil arrangement 120 to reduce the difference between current vessel heave and the heave set-point by a second control loop 420 external to the first control loop 410.

According to some aspects, the method 700 comprises controlling S5 pitch θ of the vessel 100 to reduce a difference between a current vessel pitch and a pitch set-point by the rear hydrofoil arrangement 130. The control of pitch θ can, for instance, be implemented in a separate loop 430 as exemplified in FIG. 4.

According to some aspects, the method 700 comprises controlling S6 roll φ of the vessel 100 to reduce a difference between a current vessel roll and a roll set-point by the rear hydrofoil arrangement 130. The control of roll φ can, for instance, be implemented in a separate loop 440 as exemplified in FIG. 4. The method 700 may for instance comprise controlling S61 the roll φ of the vessel 100 based on a rudder turn angle 450, as illustrated in FIG. 4.

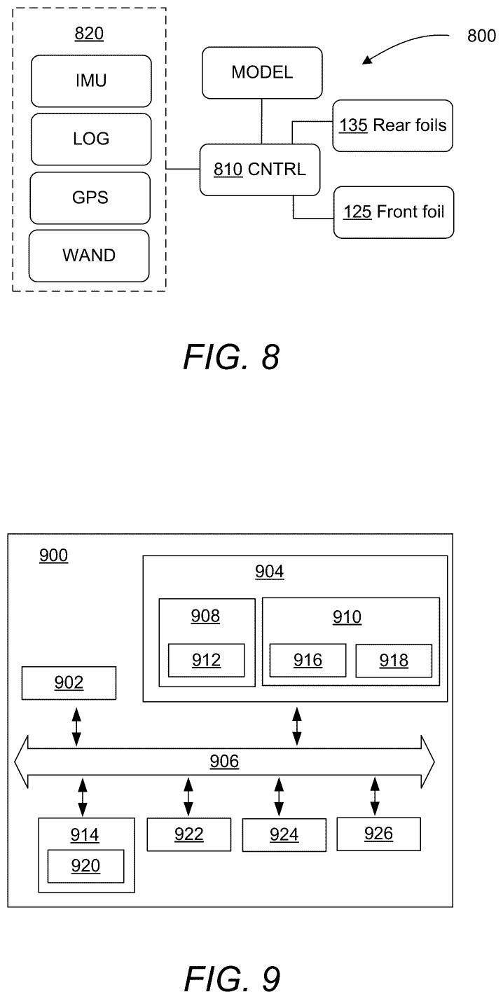

FIG. 8 schematically illustrates an example 800 of a more general implementation of the techniques described herein. A control unit 810 receives sensor input data from one or more sensor units 820, such as an IMU, a speed log, and a satellite positioning system. The control unit 810 then controls the set angle or set angles of at least a rear hydrofoil arrangement angle actuator 135 and a front hydrofoil arrangement angle actuator 125.

FIG. 9 is a schematic diagram of a computer system 900 for implementing examples disclosed herein. The computer system 900 is adapted to execute instructions from a computer-readable medium to perform these and/or any of the functions or processing described herein. The computer system 900 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A computer system comprising processing circuitry configured to: obtain data indicative of a target total lift force to be generated by a front hydrofoil arrangement of a marine vessel and by a rear hydrofoil arrangement of the marine vessel, wherein the target total lift force is associated with a constant heave of the vessel; determine a lift force discrepancy between a current lift force of the vessel and the target total lift force, based on a state of the rear hydrofoil arrangement; and adjust an angle of attack of the front hydrofoil arrangement to compensate for the lift force discrepancy.

Example 2: The computer system of Example 1, wherein the processing circuitry is configured to determine the target total lift force based on: data indicative of a mass of the vessel, and a model of lift force by the front hydrofoil arrangement and by the rear hydrofoil arrangement.

Example 3: The computer system of any of Examples 1-2, wherein the processing circuitry is further configured to determine the lift force discrepancy based on: a current pitch of the vessel, a speed through water of the vessel, and a total rear lift force currently generated by the rear hydrofoil arrangement.

Example 4: The computer system of any of Examples 1-3, wherein the processing circuitry is further configured to determine a current lift force generated by the front hydrofoil arrangement, and a current lift force generated by the rear hydrofoil arrangement, respectively, as: as:

$${F}_{L , front} = \frac{{v}^{2} {A}_{f} ρ {C}_{L} ( {β}_{f} )}{2} , and {F}_{L , rear , tot} = {F}_{L , rear , 1} + {F}_{L , rear , 2} = \frac{{v}^{2} {A}_{r 1} ρ {C}_{L} ( {β}_{r 1} )}{2} + \frac{{v}^{2} {A}_{r 2} ρ {C}_{L} ( {β}_{r 2} )}{2} ,$$

where v is a speed through water of the vessel, A_{f}, Aᵣ₁, and Aᵣ₂ are wing areas associated with the front hydrofoil arrangement and with the rear hydrofoil arrangement respectively, ρ is a water density, C_{L}(·) is a lift coefficient as function of an attack angle, β_{f}, βᵣ₁, βᵣ₂, associated with the front hydrofoil arrangement, and with the rear hydrofoil arrangement, respectively.

Example 5: The computer system of any of Examples 1-4, wherein the processing circuitry is further configured to determine a desired set angle of the front hydrofoil arrangement, as:

$${α}_{f} = \frac{2 ( m g - {F}_{L , rear , t o t} )}{{v}^{2} {A}_{f} ρ k} - θ - \frac{c}{k} ,$$

where m is vessel mass, g is a gravitational acceleration on Earth, F_{L,rear,tot} is a current lift force generated by the rear hydrofoil arrangement, v is a speed through water of the vessel, ρ is a water density, A_{f} is a wing area of the front hydrofoil arrangement, θ is a pitch of the vessel, and where a lift coefficient C_{L} of the front hydrofoil arrangement is approximated by a straight line given by C_{L}≈ka_{f}+c.

Example 6: The computer system of any of Examples 1-5, wherein the processing circuitry is further configured to control heave of the vessel to reduce a difference between a current vessel heave and a heave set-point by the front hydrofoil arrangement.

Example 7: The computer system of any of Examples 1-6, wherein the processing circuitry is further configured to control pitch of the vessel to reduce a difference between a current vessel pitch and a pitch set-point by the rear hydrofoil arrangement.

Example 8: The computer system of any of Examples 1-7, wherein the processing circuitry is further configured to control roll of the vessel to reduce a difference between a current vessel roll and a roll set-point by the rear hydrofoil arrangement.

Example 9: The computer system of Example 8, wherein the processing circuitry is further configured to control the roll of the vessel based on a rudder turn angle.

Example 10: A marine vessel comprising a front hydrofoil arrangement, a rear hydrofoil arrangement, and the computer system according to any of Examples 1-9.

Example 11: The marine vessel of Example 10, wherein the front hydrofoil arrangement and the rear hydrofoil arrangement are arranged to lift the marine vessel out of the water into a hydrofoiling state where a hull of the vessel is elevated from a nominal draught state to a state of reduced draught.

Example 12: A hydrofoiling system comprising at least a front hydrofoil arrangement, a rear hydrofoil arrangement, and the computer system according to any of Examples 1-9.

Example 13: A computer-implemented method for controlling a hydrofoiling operation by a marine vessel, comprising: obtaining, by processing circuitry of a computer system, data indicative of a target total lift force to be generated by a front hydrofoil arrangement of the marine vessel and by a rear hydrofoil arrangement of the marine vessel, wherein the target total lift force is associated with a constant heave of the vessel; determining, by the processing circuitry, a lift force discrepancy between a current lift force of the vessel and the target total lift force, based on a state of the rear hydrofoil arrangement; and adjusting an angle of attack of the front hydrofoil arrangement to reduce the lift force discrepancy.

Example 14: A computer program product comprising program code for performing, when executed by the processing circuitry, the method of Example 13.

Example 15: A non-transitory computer-readable storage medium comprising instructions, which when executed by the processing circuitry, cause the processing circuitry to perform the method of Example 13.

Example 16: A computer implemented method, performed by a control unit for controlling a hydrofoiling operation by a marine vessel, the vessel comprising at least a front hydrofoil arrangement and a rear hydrofoil arrangement, the method comprising: obtaining data indicative of a target total lift force to be generated by the front hydrofoil arrangement and by the rear hydrofoil arrangement, where the target total lift force is associated with a constant heave of the vessel, determining a lift force discrepancy between a current lift force of the vessel and the target total lift force, based on a state of the rear hydrofoil arrangement, and adjusting an angle of attack of the front hydrofoil arrangement to reduce the lift force discrepancy.

Example 17: The computer implemented method according to Example 16, comprising determining the target total lift force based on data indicative of a mass of the vessel, and on a model of lift force by the front hydrofoil arrangement and by the rear hydrofoil arrangement.

Example 18: The computer implemented method according to Example 16 or 17, comprising determining the lift force discrepancy based on a current pitch of the vessel, a speed through water of the vessel, and on a total rear lift force currently generated by the rear hydrofoil arrangement.

Example 19: The computer implemented method according to any previous Example, comprising determining a current lift force of the front hydrofoil arrangement, and of the rear hydrofoil arrangement, respectively, as

$${F}_{L , front} = \frac{{v}^{2} {A}_{f} ρ {C}_{L} ( {β}_{f} )}{2} , {F}_{L , rear , tot} = {F}_{L , rear , 1} + {F}_{L , rear , 2} = \frac{{v}^{2} {A}_{r 1} ρ {C}_{L} ( {β}_{r 1} )}{2} + \frac{{v}^{2} {A}_{r 2} ρ {C}_{L} ( {β}_{r 2} )}{2} ,$$

where v is a speed through water of the vessel, wing areas are associated with the front hydrofoil arrangement and with the rear hydrofoil arrangement respectively, is a water density, is a lift coefficient as function of an attack angle, associated with the front hydrofoil arrangement and with the rear hydrofoil arrangement respectively.

Example 20: The computer implemented method according to any previous Example, comprising determining a desired set angle of the front hydrofoil arrangement, as

$${α}_{f} = \frac{2 ( m g - {F}_{L , rear , t o t} )}{{v}^{2} {A}_{f} ρ k} - θ - \frac{c}{k} ,$$

where m is vessel mass, g is a gravitational acceleration on Earth, is a current lift force generated by the rear hydrofoil arrangement, v is a speed through water of the vessel, is a water density, wing area of the front hydrofoil arrangement, is a pitch of the vessel, and where a lift coefficient of the front hydrofoil arrangement is approximated by a straight line given by C_{L}≈ka_{f}+c.

Example 21: The computer implemented method according to any previous Example, comprising controlling heave of the vessel to reduce a difference between a current vessel heave and a heave set-point by the front hydrofoil arrangement.

Example 22: The computer implemented method according to Example 21, comprising controlling heave of the vessel by the front hydrofoil arrangement to reduce the difference between current vessel heave and the heave set-point by a second control loop external to the first control loop.

Example 23: The computer implemented method according to any previous Example, comprising controlling pitch of the vessel to reduce a difference between a current vessel pitch and a pitch set-point by the rear hydrofoil arrangement.

Example 24: The computer implemented method according to any previous Example, comprising controlling roll of the vessel to reduce a difference between a current vessel roll and a roll set-point by the rear hydrofoil arrangement.

Example 25: The computer implemented method according to Example 24, comprising controlling the roll of the vessel based on a rudder turn angle.

Example 26: The computer implemented method according to any previous Example, where the front hydrofoil arrangement and the rear hydrofoil arrangement are arranged to lift the vessel out of the water into a hydrofoiling state where a hull of the vessel is elevated from a nominal draught state to a state of reduced draught.

Example 27: A computer program product comprising program code for performing, when executed by processing circuitry, the method of any previous Example.

Example 28: A non-transitory computer-readable storage medium comprising instructions, which when executed by processing circuitry, cause the processing circuitry to perform the method of any of Examples 16-26.

Example 29: A control unit for controlling a hydrofoiling operation by a marine vessel, the vessel comprising a front hydrofoil arrangement and a rear hydrofoil arrangement, the control unit comprising processing circuitry configured to: obtain data indicative of a target total lift force to be generated by the front hydrofoil arrangement and by the rear hydrofoil arrangement, where the target total lift force is associated with a constant heave of the vessel, determine a lift force discrepancy between a current lift force of the vessel and the target total lift force, based on a state of the rear hydrofoil arrangement, and adjust an angle of attack of the front hydrofoil arrangement to compensate for the lift force discrepancy.

Example 30: A marine vessel comprising a front hydrofoil arrangement, a rear hydrofoil arrangement, and a control unit according to Example 29.

Example 31: A hydrofoiling system comprising at least a front hydrofoil arrangement, a rear hydrofoil arrangement, and a control unit according to Example 29.

The terminology used herein is for the purpose of describing particular aspects only and is not intended to be limiting of the disclosure. As used herein, the singular forms “a”, “an”, and “the” are intended to include the plural forms as well, unless the context clearly indicates otherwise. As used herein, the term “and/or” includes any and all combinations of one or more of the associated listed items. It will be further understood that the terms “comprises”, “comprising”, “includes”, and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A computer system comprising processing circuitry configured to:
obtain data indicative of a target total lift force to be generated by a front hydrofoil arrangement of a marine vessel and by a rear hydrofoil arrangement of the marine vessel, wherein the target total lift force is associated with a constant heave of the vessel;
determine a lift force discrepancy between a current lift force of the vessel and the target total lift force, based on a state of the rear hydrofoil arrangement; and
adjust an angle of attack of the front hydrofoil arrangement to compensate for the lift force discrepancy.

2. The computer system of claim 1, wherein the processing circuitry is configured to determine the target total lift force based on:
data indicative of a mass of the vessel, and
a model of lift force by the front hydrofoil arrangement and by the rear hydrofoil arrangement.

3. The computer system of claim 1, wherein the processing circuitry is further configured to determine the lift force discrepancy based on:
a current pitch of the vessel,
a speed through water of the vessel, and
a total rear lift force currently generated by the rear hydrofoil arrangement.

4. The computer system of claim 1, wherein the processing circuitry is further configured to determine a current lift force F_{L,front} generated by the front hydrofoil arrangement, and a current lift force F_{L,rear,tot} generated by the rear hydrofoil arrangement, respectively, as:
$${F}_{L , front} = \frac{{v}^{2} {A}_{f} ρ {C}_{L} ( {β}_{f} )}{2} , and {F}_{L , r e a r , t o t} = {F}_{L , r e a r , 1} + {F}_{L , r e a r , 2} = \frac{{v}^{2} {A}_{r 1} ρ {C}_{L} ( {β}_{r 1} )}{2} + \frac{{v}^{2} {A}_{r 2} ρ {C}_{L} ( {β}_{r 2} )}{2} ,$$
where v is a speed through water of the vessel, A_{f}, Aᵣ₁, and Aᵣ₂ are wing areas associated with the front hydrofoil arrangement and with the rear hydrofoil arrangement respectively, ρ is a water density, C_{L}(·) is a lift coefficient as function of an attack angle, β_{f}, βᵣ₁, βᵣ₂, associated with the front hydrofoil arrangement, and with the rear hydrofoil arrangement, respectively.

5. The computer system of claim 1, wherein the processing circuitry is further configured to determine a desired set angle of the front hydrofoil arrangement, as:
$${α}_{f} = \frac{2 ( m g - {F}_{L , rear , t o t} )}{{ν}^{2} {A}_{f} ρ k} - θ - \frac{c}{k} ,$$
where m is vessel mass, g is a gravitational acceleration on Earth, F_{L,rear,tot} is a current lift force generated by the rear hydrofoil arrangement, v is a speed through water of the vessel, ρ is a water density, A_{f} is a wing area of the front hydrofoil arrangement, θ is a pitch of the vessel, and where a lift coefficient C_{L} of the front hydrofoil arrangement is approximated by a straight line given by C_{L}≈ka_{f}+c.

6. The computer system of claim 1, wherein the processing circuitry is further configured to control heave of the vessel to reduce a difference between a current vessel heave and a heave set-point by the front hydrofoil arrangement.

7. The computer system of claim 1, wherein the processing circuitry is further configured to control pitch of the vessel to reduce a difference between a current vessel pitch and a pitch set-point by the rear hydrofoil arrangement.

8. The computer system of claim 1, wherein the processing circuitry is further configured to control roll of the vessel to reduce a difference between a current vessel roll and a roll set-point by the rear hydrofoil arrangement.

9. The computer system of claim 8, wherein the processing circuitry is further configured to control the roll of the vessel based on a rudder turn angle.

10. A marine vessel comprising a front hydrofoil arrangement, a rear hydrofoil arrangement, and the computer system according to claim 1.

11. The marine vessel of claim 10, wherein the front hydrofoil arrangement and the rear hydrofoil arrangement are arranged to lift the marine vessel out of the water into a hydrofoiling state where a hull of the vessel is elevated from a nominal draught state to a state of reduced draught.

12. A hydrofoiling system comprising at least a front hydrofoil arrangement, a rear hydrofoil arrangement, and the computer system) according to claim 1.

13. A computer-implemented method for controlling a hydrofoiling operation by a marine vessel, comprising:
obtaining, by processing circuitry of a computer system, data indicative of a target total lift force to be generated by a front hydrofoil arrangement of the marine vessel and by a rear hydrofoil arrangement of the marine vessel, wherein the target total lift force is associated with a constant heave of the vessel;
determining, by the processing circuitry, a lift force discrepancy between a current lift force of the vessel and the target total lift force, based on a state of the rear hydrofoil arrangement; and
adjusting an angle of attack of the front hydrofoil arrangement to reduce the lift force discrepancy.

14. A computer program product comprising program code for performing, when executed by the processing circuitry, the method of claim 13.

15. A non-transitory computer-readable storage medium comprising instructions, which when executed by the processing circuitry, cause the processing circuitry to perform the method of claim 13.
